(19) United States
(12) Patent Application Publication
(10) Pub. No.: US 2014/0072867 A1
(43) Pub. Date: Mar. 13, 2014

(54) METHOD FOR MANUFACTURING AN ELECTRODE

(71) Applicant: Li-Tec Battery GmbH, Kamenz (DE)

(72) Inventors: Hubert VONDERHAGEN, Hersdorf (DE); Lothar THOMMES, Bitburg-Stahl (DE); Steffen LEGNER, Ellwangen (DE); Claus-Rupert HOHENTHANNER, Hanau (DE)

(73) Assignee: Li-Tec Battery GmbH, Kamenz (DE)

(21) Appl. No.: 14/081,266

(22) Filed: Nov. 15, 2013

Related U.S. Application Data
(63) Continuation of application No. 13/877,697.

(30) Foreign Application Priority Data
Oct. 6, 2010 (DE) 10 2010 047 642.0

(51) Int. Cl. H01M 4/02; H01M 4/04

(52) U.S. Cl. CPC H01M 4/02; H01M 4/04
USPC 429/209; 83/13

(57) ABSTRACT

An electrode (1) for an electrochemical energy storage apparatus has a contour (2) exhibiting two side edges, wherein a first side edge (3) and a second side edge (4) are interconnected by a connecting section (5). The connecting section (5) comprises a substantially linear region (5a) which transitions into the first side edge (3), and a substantially curved region (5b) which transitions into the second side edge (4). When manufacturing such an electrode the first side edge (3) is created by a first cut, the second side edge (4) is created by a second cut, and the connecting section (5) is created along with the first cut or the second cut.

### CROSS REFERENCE TO RELATED APPLICATIONS

This application is a continuation of U.S. application Ser. No. 13/877,697 filed Apr. 4, 2013, which is a National Phase of PCT/EP2011/004966, filed Oct. 5, 2011 and claims priority to German Application No. 10 2010 047 642.0 filed Oct. 6, 2010. The entire contents of these applications are being incorporated herein by reference.

### DESCRIPTION

The invention relates to a method for manufacturing an electrode as well as an electrode produced by such a method, particularly for an electrochemical energy storage apparatus.

Increasing attention has been given as of late to the development of electrochemical energy storage apparatus due to their being used in ever greater numbers to store energy in, for example, electronic items, motor vehicles and power plants. Since electrochemical energy storage apparatus are thus mass-produced articles, in addition to their technical properties, increased importance is also attached to their manufacturing process.

Generally speaking, an electrochemical energy storage apparatus comprises at least one electrochemical cell. The latter in turn comprises a casing which delimits an electrochemically active part from the environment. This electrochemically active part of the cell normally comprises, particularly in the case of rectangular or coffee bag-type energy storage cells, a plurality of sheet-like anodes, cathodes and separators alternatingly positioned atop one another and thus forming an electrode stack. An electrolyte is at least partially accommodated in the separators.

In short, anodes and cathodes can be called electrodes. Such electrodes are usually cut from a band or plate-shaped semi-finished product. Due to the number of electrodes needed when manu-facturing electrochemical energy storage apparatus, this cutting procedure is of high importance.

Providing sharp-edged corners of sheet metal or similar semi-finished product with radii, whereby sharp-edged corners preferably refer to sharp-angled transitions from a first cut edge to a second cut edge, is known from the prior art. Due to their geometrical shape, corner or edge regions are often vulnerable to external and/or thermal stress. Providing radii at these vulnerable sections can lower such loads. The risk of the adjoining cell casing cracking and/or experiencing wear can furthermore be reduced and thus the service life of these components extended.

In addition, the storage capacity of electrochemical energy storage apparatus depends on, among other things, the total area of the electrodes. Two alternatives in particular are viable for the purpose of increasing the area. On the one hand, capacity can be increased by increasing the number of electrodes in a cell; on the other hand, the area of each individual electrode can also be increased.

In order to enable electrode size to be flexibly adjusted, it is considered expedient to use tools to cut these electrodes which allow making at least one first cut and one second cut essentially independent thereof. The contour of an electrode is substantially formed by two essentially independent cuts through at least two—in the case of substantially rectangular electrodes, preferably four—essentially independent cut edges.

It is the object of the invention to provide an improved method of manufacturing an electrode as well as an improved electrode.

According to the invention, this object is achieved by the teachings of the independent claims. Preferred further developments of the invention are subject matter of the subclaims.

The electrode according to the invention has a contour exhibiting two side edges, wherein a first side edge and a second side edge are interconnected by a connecting section. The connecting section exhibits a substantially linear region which transitions into the first side edge and a substantially curved region which transitions into the second side edge. When such an electrode is being produced, the first side edge is created by a first cut, the second side edge is created by a second cut, and the connecting section is created along with the first cut or the second cut.

In the inventive electrode, the connecting section comprises a linear section and a curved section between the electrode's two side edges. This keeps the edges or edge sections of the electrode from not being cut at an acute angle. In other words, sharp edges; i.e. corners with inner angles of 90° or less, can be prevented on the electrode. As a result, the mechanical and thermal stress on the electrode in the area of the connecting section can be reduced and the risk of damage to the adjoining casing in the area of the connecting section can be decreased. This can increase the service life of an electrochemical cell provided with such an electrode, for example.

To be understood by an “electrochemical energy storage apparatus” in the present case is any type of energy storage means from which electrical energy can be withdrawn, whereby an electrochemical reaction occurs within the interior of the energy storage means. The term encompasses energy storage means of all types, particularly primary batteries, secondary batteries and fuel cells. The electrochemical energy storage apparatus comprises at least one electrochemical cell, preferen-tially a plurality of electrochemical cells. The plurality of electrochemical cells can be connected in parallel to store a larger amount of charge or connected in series to realize a desired operating voltage or can form a combined parallel/series connection.

An “electrochemical cell” hereby refers to an apparatus which serves in the discharging of electrical energy, whereby the energy is stored in chemical form. In the case of rechargeable secondary batteries, the cell is also designed to absorb electrical energy, convert it into chemical energy and store it. The design (i.e. the size and geometry in particular) of an electrochemical cell can be selected as a function of the given available space. The electrochemical cell is preferentially of substantially prismatic or cylindrical configuration. The present invention is in particular advan-tageously applicable to electrochemical cells known as pouch cells or coffee bag cells, without the electrochemical cell of the present invention being limited to this application. In conjunction hereto, an “electrode stack” is to be understood as an assembly of at least two electrodes and an electrolyte arranged between them. The electrolyte can be partially accommodated by a separator, whereby the separator then separates the electrodes. Preferably, the electrode stack comprises a plurality of layers of electrodes and separators, wherein the electrodes of like polarity are preferably each electrically interconnected, particularly in parallel. The electrodes are of e.g. plate-shaped or foil-like configuration and preferably arranged substantially parallel to one another (prismatic energy storage cells). The electrode stack can also be coiled and exhibit a substantially cylindrical shape (cylindrical energy storage cells). The term “electrode stack” is also to include such electrode coils. The electrode stack can comprise lithium or another alkali metal, also in ionic form.

In the context of the present invention, the term “electrode” is to denote a substantially plate-shaped element of an electrically conductive material (preferably metal or a metal alloy). The thickness of the electrode can thereby range from the thickness of foil up to a plate thickness of several millimeters. The contour; i.e. the basic form of the electrode, is in principle discretionary. The electrode preferably has an essentially rectangular basic form with four side edges which meet substantially at right angles.

To be understood by the “contour” of the electrode is the electrode's preferably closed peripheral boundary. The electrode's contour preferably exhibits a substantially polygonal form. It is further preferable for the electrode's contour to be defined by at least one first and one second side edge, preferentially two first and two second side edges. The electrode's contour preferably exhibits at least two linear sections.

The term “connecting section” refers to a section of the electrode's contour which connects a first side edge to a second side edge. A connecting section preferably connects side edges which intersect at an angle greater than 60°, preferentially greater than 80° and/or preferably less than 120°, preferentially less than 100°, and particularly preferentially said side edges intersect at a substantially right angle.

The term “semi-finished product” encompasses prefabricated raw material blanks which require further processing in order to produce an end product. The semi-finished product is preferably provided in the form of a band; i.e. in continuous form, or in the form of a plate; i.e. individual pieces. To hereby be understood by band-shaped or plate-shaped semi-finished product is semi-finished product which exhibits a large extension in a first and second spatial direction compared to its lower degree of thickness. The thickness can thereby range from the thickness of foil up to a plate thickness of several millimeters. To produce electrodes having the thickness of foil, the thickness of the semi-finished product is preferably less than 1 mm, preferentially less than 0.3 mm, particularly preferentially less than 0.15 mm and/or greater than 0.05 mm, preferentially greater than 0.1 mm and particularly preferentially greater than 0.125 mm.

The term “cutting” in the present context is to be understood as all mechanical and non-mechanical separating methods suited to produce an electrode with a desired contour from a semi-finished product in the form of a band or a plate. Such separating methods particularly include mechanical processes such as punching, cutting, serration and the like, as well as non-mechanical processes such as laser cutting, water jet cutting and the like. The electrode's contour is preferably produced by a plurality of cuts or cutting operations which form the side edges and the connecting sections of the electrode's contour. A cut edge hereby preferably refers to a contiguous section of a dividing line between the provided semi-finished product and the electrode. At least one, preferentially two, cut edges are preferably produced in one cutting operation. Preferably, the cut edges produced in one cutting operation are substantially parallel to one another.

The “linear region” of the connecting section refers to a section of the electrode's contour not exhibiting any curvature. The linear region preferably adjoins the curved region of the connecting section.

The “curved region” of the connecting section refers to a section of the electrode's contour which does exhibit a curvature. The curvature is preferably of substantially convex configuration. The curvature is preferably provided in continuous fashion in the curved region of the connecting section. The curved region of the connecting section preferably adjoins the second side edge of the electrode. It is further preferred for the curved region to adjoin the linear region of the connecting section.

In a preferred embodiment, the curved region of the connecting section exhibits a substantially circular behaviour. It is further preferred for this section to exhibit a preferably constant radius. The radius is preferably in a range of between approximately 1 mm and approximately 10 mm, preferentially between approximately 2 mm and approximately 6 mm, and particularly preferentially is approximately 3 mm. A radius of the described size lowers the disadvantageous stressing of the electrode contour's corners on the one hand and, on the other, keeps the area of the electrode through the curved region relatively large.

In a preferred embodiment, the curved region of the connecting section can be substantially described by an opening angle. Said opening angle is preferably greater than 30°, preferentially greater than 40° and/or preferably less than 60°, preferentially less than 50°, and particularly preferentially is approximately 45°. An opening angle to the curved section configured at the described size achieves being able to keep the area of the electrode through the connecting section relatively large and lessens the stress on the corners.

In a preferred embodiment, the curved region of the connecting section transitions substantially tangentially into the electrode's second side edge. Preferably, the curved region of the connecting section tangentially transitions into the side edge which is not intersected by the linear region of the connecting section. This tangential transition advantageously prevents a discontinuity in the electrode's contour and can thus reduce the stress on same and provide an improved method for cutting out the electrode.

In a preferred embodiment, the linear region of the connecting section intersects the first side edge of the electrode at an angle preferably greater than 15°, preferentially greater than 25° and/or preferably less than 60°, preferentially less than 50° and particularly preferentially at approximately 45°. What an angle within the described angular range achieves is that, on the one hand, the area of the electrode through the connecting section will only be insignificantly reduced and, on the other, that the stress on the corners at the transition from the linear region of the connecting section to the side edge will remain low.

In a preferred embodiment, the curved region of the connecting section transitions substantially tangentially into the linear region of the connecting section. This tangential transition advantageously prevents a discontinuity in the electrode's contour at the point of transition between the two connecting section regions which would have negative consequences in terms of the stress on the electrode or the service life of the adjoining cell casing.

In a preferred embodiment, the electrode exhibits a substantially rectangular form. It is further preferable for each two side edges to interconnected by a connecting section configured in accordance with the invention. The electrode preferentially exhibits four connecting sections and all the side edges are connected together by means of same. This design gives the electrode a contour which is invulnerable to external stresses in the region and which exhibits a relatively large area. The described configuration of the electrode thus provides a preferably large-area and preferentially invulnerable electrode. This electrode moreover advantageously lowers the risk of damage to the adjacent cell casing, e.g. caused by sharp edges or corners.

The following description made in conjunction with the accompanying figures will yield further features, advantages and conceivable applications of the present invention.

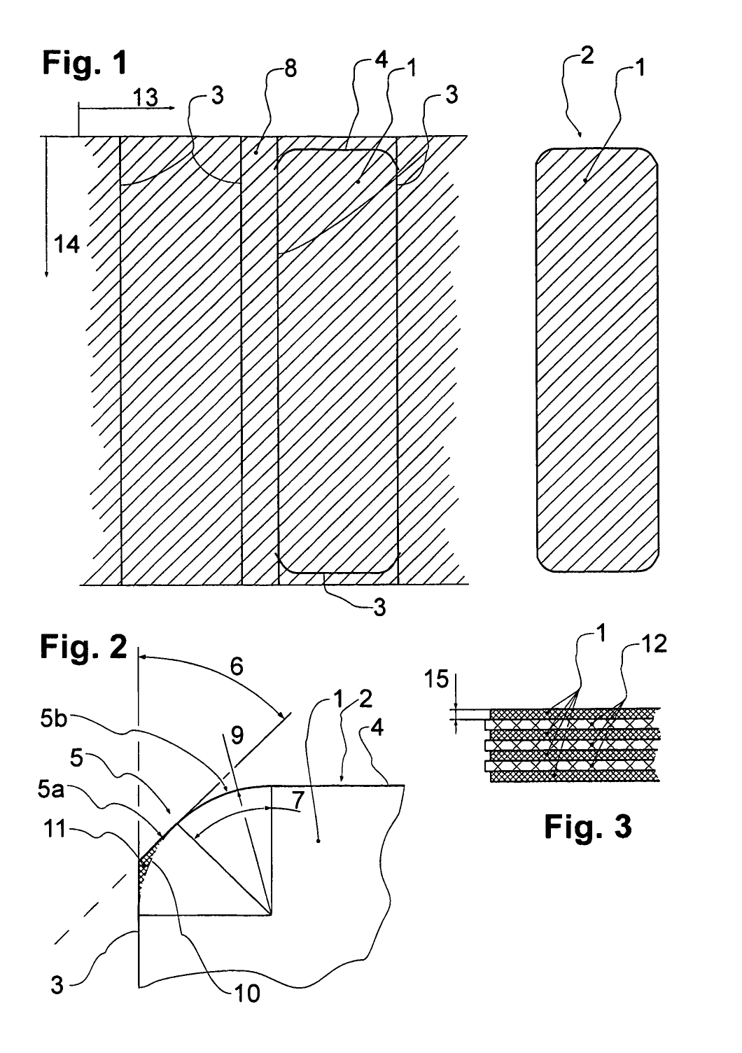

FIG. 1 shows first and second cuts on a band-shaped semi-finished product for producing an electrode in accordance with the invention;

FIG. 2 shows a schematic partial view to illustrate the contour of the electrode in the region of a connecting section between two side edge of the electrode; and

FIG. 3 shows a schematic partial view of an electrode stack.

FIG. 1 shows a band-shaped semi-finished product 8 which substantially extends in a first spatial direction 13 and a second spatial direction 14. The thickness of this semi-finished product (see FIG. 3 on this) is small in relation to this first and second spatial direction 13, 14, for example only has the thickness of foil.

A first cutting operation into the semi-finished product 8 creates two first cut edges which ultimately form two first side edges 3 of the electrode 1 and a second cutting operation creates two further cut edges which ultimately form two second side edges 4 of the electrode 1. In the process, the second cutting operation can also be performed prior to the first cutting operation. These two cutting operations produce the contour 2 of the electrode 1. The two cutting operations are prefera-bly performed such that the electrode 1 is completely separated from the semi-finished product 8.

While each of the cut edges 3 in the FIG. 1 embodiment extend over the entire width 14 of the semi-finished product 8, these cuts can also be shorter and only extend out to approximately the area where they intersect the other cut edges 4. Depending on the type of cutting operation, this approach can result in a temporally shorter cutting operation.

FIG. 2 shows the connecting section 5 between a first side edge 3 and a second side edge 4 of the electrode 1. In particular, the connecting section 5 exhibits a linear region 5a and a curved region 5b. The linear region 5a transitions into the first side edge 3 of the electrode 1 at an (external) angle 6 of less than 90° while the curved region 5b transitions into the second side edge 4 substantially tangentially. The linear region 5a of connecting section 5 further transitions substantially tangentially into the curved region 5b. The labeling of the first and second side edges can alternatively also be reversed.

The curved region 5b of connecting section 5 exhibits a substantially circular form with a radius 9 and an opening angle 7. The linear region 5a intersects the first side edge 3 at an angle 6, as illustrated in FIG. 2.

In the embodiment depicted, the radius 9 of the curved region 5b of connecting section 5 amounts to approximately 4 mm, the opening angle 7 of the curved region 5b of connecting section 5 amounts to approximately 45°, and the intersecting angle 6 between the linear region 5a of connecting section 5 and the first side edge 3 of the electrode 1 amounts to approximately 45°, without the present invention being limited to these numerical values.

Compared to having an absolute rounding between the first side edge 3 and the second side edge 4 of the electrode 1, which can be described by a curvature radius 10, the area of electrode 1 is enlarged in the inventive manufacturing process by the area gain 11, as illustrated in FIG. 2. The total area gain of a substantially rectangular electrode 1 then consists of a total of four such area gains 11, and the total area gain for an electrochemical energy storage cell consists of a plurality of area gains 11 for a plurality of electrodes 1. This plurality of area gains 11 can increase the capacity of the electrochemical energy storage apparatus.

FIG. 3 shows a detail of an electrode stack, whereby said electrode stack exhibits a plurality of electrodes 1 and a plurality of separators 12 between the electrodes 1. The separators 12 are arranged such that two electrodes 1 are separated from one another by one of said separators 12. The electrodes 1 substantially exhibit the thickness 15 of the semi-finished product 8. Different electrodes 1 can be produced from different semi-finished product 8 and thus exhibit different thicknesses 15.

### LIST OF REFERENCE NUMERALS

1 electrode

2 contour of electrode

3 first side edge

4 second side edge

5 connecting section

5a linear region of the connecting section

5b curved region of the connecting section

6 intersecting angle

7 opening angle

8 semi-finished product

9 radius of curved region 5b

10 curvature radius

11 area gain

12 separator

13 first spatial direction

14 second spatial direction

15 semi-finished product/electrode thickness

1. A method for manufacturing an electrode from a band or plate-shaped semi-finished product, for an electrochemical energy storage apparatus, which has a contour comprising two side edges, wherein a first side edge and a second side edge intersect at an angle greater than 60° and less than 120° degrees and are interconnected by a connecting section, in which the first side edge is created by a first cut and the second side edge is created by a second cut, wherein
the connecting section comprises a linear region adjoining the first side edge and a curved region adjoining the second side edge on one side and the linear region of the connecting section on another side; and
wherein the connecting section is created along with the first cut or the second cut.

2. The method according to claim 1, wherein the curved region of the connecting section is circular.

3. The method according to claim 2, wherein a radius of the curved region of the connecting section is in a range of 1 mm to 10 mm.

4. The method according to claim 1, wherein the curved region of the connecting section comprises an opening angle in a range of from 30° to 60°.

5. The method according to claim 1, wherein the curved region of the connecting section transitions tangentially into the second side edge of the electrode.

6. The method according to claim 1, wherein the linear region of the connecting section intersects the first side edge of the electrode at an angle in a range of from 15° to 60°.

7. The method according to claim 1, wherein the curved region of the connecting section transitions tangentially into the linear region of the connecting section.

8. A plate-shaped electrode for an electrochemical energy storage apparatus, including a contour comprising two side edges, wherein a first side edge and a second side edge intersect at an angle greater than 60° and less than 120° and are interconnected by a connecting section, wherein
the connecting section comprises a linear region which transitions into the first side edge and a curved region which transitions into the second side edge on one side and the linear region of the connecting section on another side.

9. The electrode according to claim 8, wherein the electrode comprises a rectangular form including total of four side edges, two respective side edges being are connected to a connecting section in accordance with claim 8.

10. The electrode according to claim 8, wherein the curved region of the connecting section comprises a circular form a radius of the curved region being in a range of 1 mm to 10 mm.

11. The electrode according to claim 8, wherein the curved region of the connecting section includes an opening angle in a range of from 30° to 60°.

12. The electrode according to claim 8, wherein the linear region of the connecting section intersects the first side edge at an angle in a range of 15° to 60°.

13. The electrode according to claim 8, wherein the curved region of the connecting section transitions tangentially into the linear region of the connecting section.

14. An electrochemical cell comprising at least one electrode in accordance with claim 8.

15. The method according to claim 3, wherein the radius of the curved region of the connecting section is in a range of 2 mm to 6 mm.

16. The method according to claim 4, wherein the opening angle is in a range of 40° to 50°.

17. The method according to claim 6, wherein the angle at which the linear region intersects the connecting section is in a range of 25° to 50°.

18. The electrode according to claim 10, wherein the radius of the curved region is in a range of 2 mm to 6 mm.

19. The electrode according to claim 11, wherein the opening angle is in a range of 40° to 50°.

20. The electrode according to claim 12, wherein the angle at which the linear region intersects the connecting section is in a range of 25° to 50°.
